(19) United States
(12) Patent Application Publication
(10) Pub. No.: US 2011/0107275 A1
(43) Pub. Date: May 5, 2011

(54) METHOD OF TESTING A CURSOR INTERACTIVE WITH A POINTING DEVICE ON A DISPLAYING DEVICE

(76) Inventors: Cheng-Hsing Kuo, Taipei Hsien (TW); Yen-Hui Wang, Taipei Hsien (TW); Tung-Jung Wu, Taipei Hsien (TW)

(21) Appl. No.: 12/714,556

(22) Filed: Mar. 1, 2010

(30) Foreign Application Priority Data
Nov. 5, 2009 (TW) 098137576

(51) Int. Cl. G06F 3/048

(52) U.S. Cl. 715/856

(57) ABSTRACT

A method of testing a cursor interactive with a pointing device on a displaying device includes pointing at a position on a displaying device by the pointing device within a predetermined period, identifying whether a movement of the cursor makes any change corresponding to the pointing device, and concluding a testing result in accordance with the movement of the cursor.

### BACKGROUND OF THE INVENTION

1. Field of the Invention

The present invention relates to a method of testing a cursor interactive with a pointing device on a displaying device, and more particularly, to a method of testing a cursor interactive with a pointing device on a displaying device by a regional test, a pointing test, and a slight moving test.

2. Description of the Prior Art

A pointing device is often utilized to control movements of a cursor and an image shown on a computer screen. The general pointing device can be a mouse, a track ball, a digitizer, a joystick, a point stick, and so on. With the advanced touch technology, a user utilizes a touch stick or a finger to be the pointing device for controlling the movements of the cursor and the image shown on the computer screen. Reliability of the pointing device and the cursor controlled by the pointing device is related to comfort operation. The user is troubled when the pointing device can not control the movement of the cursor accurately, so that an accurate method of testing the cursor of the pointing device is necessary. However, a conventional testing method only tests whether the pointing device can point coordinates and whether the pointing device can be operated roughly, which is insufficiently though rapidly. Thus, the conventional testing method still has a problem of testing the cursor of the pointing device inaccurately.

### SUMMARY OF THE INVENTION

The present invention provides a method of testing a cursor of a pointing device shown on a displaying device for solving above drawbacks.

According to the claimed invention, a method of testing a cursor interactive with a pointing device on a displaying device includes pointing at a position on a displaying device by the pointing device within a predetermined period, identifying whether a movement of the cursor makes any change corresponding to the pointing device, and concluding a testing result in accordance with the movement of the cursor.

According to the claimed invention, identifying whether the movement of the cursor makes any change corresponding to the pointing device includes capturing a first coordinates value of the cursor at an initial time and capturing a second coordinates value of the cursor at an ending time so as to identify whether a difference of the second coordinates value and the first coordinates value is smaller than a predetermined value.

According to the claimed invention, identifying the movement of the cursor without making change when the difference of the second coordinates value and the first coordinates value is smaller than the predetermined value.

According to the claimed invention, pointing at the position on the displaying device by the pointing device within the predetermined period includes pointing at the position on the displaying device in a touch manner within the predetermined period.

According to the claimed invention, the method further includes displaying at least one checking area on the displaying device, moving the pointing device for moving the cursor into the checking area, and identifying whether the cursor moves into the checking area so as to generate the testing result of the cursor.

According to the claimed invention, a method of testing a cursor of a pointing device shown on a displaying device further includes setting the predetermined tracing path of the cursor on the displaying device, displaying the movement of the cursor when manipulating the pointing device, identifying whether the movement of the cursor overlaps in the predetermined tracing path, and displaying a conclusive result on the displaying device in accordance with the identified movement of the cursor corresponding to the pointing device.

According to the claimed invention, identifying whether the movement of the cursor overlaps in the predetermined tracing path includes identifying whether the movement of the cursor on the displaying device overlaps in a width range of the predetermined tracing path.

According to the claimed invention, identifying whether the movement of the cursor overlaps in the width range of the predetermined tracing path includes capturing a coordinates value of the cursor while moving the pointing device and identifying whether the coordinates value overlaps in the width range of the predetermined tracing path.

According to the claimed invention, the method further includes identifying whether a distance of moving the cursor on the displaying device is larger than or equal to a predetermined distance.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a computer system according to a preferred embodiment of the present invention.

FIG. 2 is a flow chart of testing the cursor of a pointing device shown on a displaying device according to the preferred embodiment of the present invention.

FIG. 3 to FIG. 5 are diagrams of different testing modes shown on the displaying device according to the preferred embodiment of the present invention.

### DETAILED DESCRIPTION

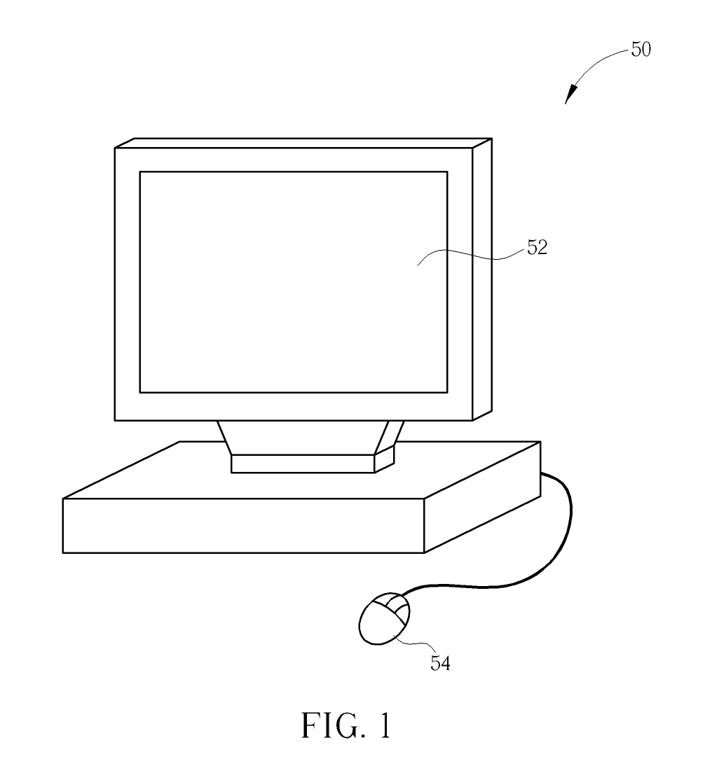

Please refer to FIG. 1. FIG. 1 is a diagram of a computer system computer system 50 according to a preferred embodiment of the present invention. The computer system 50 includes a displaying device 52 for displaying an image. The computer system 50 further includes a pointing device 54 for controlling movements of a cursor and the image on the displaying device 52. The pointing device 54 can be a human computer interface (HCI) device, such as a mouse, a track ball, a digitizer, a joystick, a point stick, and so on. The displaying device 52 can be a touch screen, a touch board, and so on. A user can utilize the pointing device 54, such as a touch pen and a finger, to control the movements of the cursor and the image on the displaying device 52 in a touch manner accordingly.

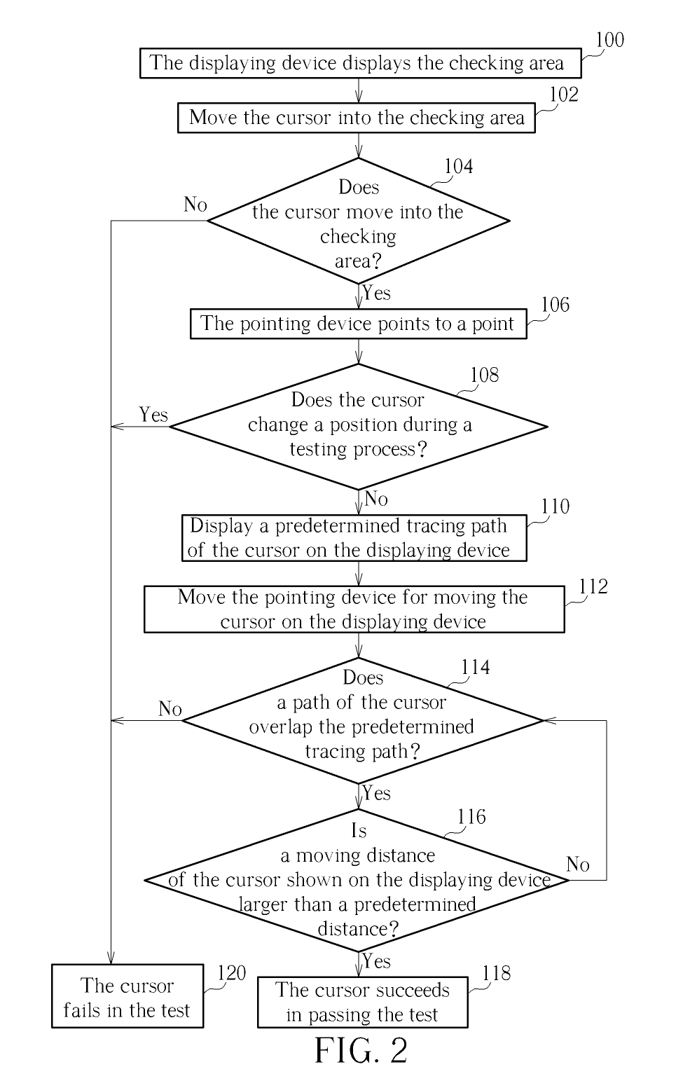

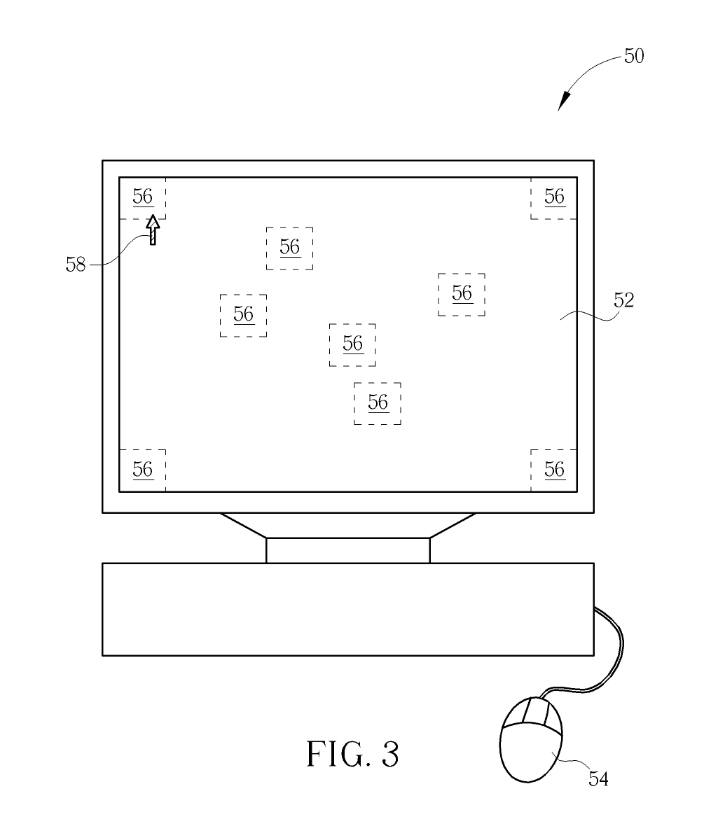

Please refer to FIG. 2 to FIG. 5. FIG. 2 is a flow chart of testing the cursor interactive with the pointing device 54 on the displaying device 52 according to the preferred embodiment of the present invention. FIG. 3 to FIG. 5 are diagrams of different testing modes on the displaying device 52 according to the preferred embodiment of the present invention. The testing method shown in FIG. 2 includes following steps:

Step 100: The displaying device 52 displays at least one checking area 56 as shown in FIG. 3;

Step 102: Manipulate the pointing device 54 for moving the corresponding cursor 58 interactive with the pointing device 54 on the displaying device 52 into the checking area 56;

Step 104: Identify whether the movement of the cursor 58 moves into the checking area 56. If yes, execute step 106. If no, execute step 120;

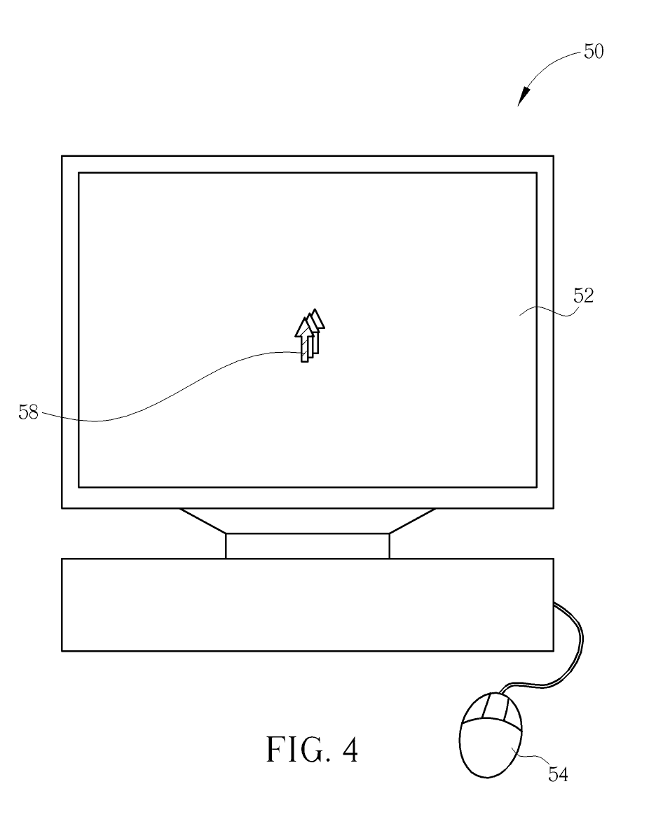

Step 106: The pointing device 54 points at a point as shown in FIG. 4;

Step 108: Identify whether the movement of the cursor makes any change corresponding to the pointing device 54. If no, execute step 110. If yes, execute step 120;

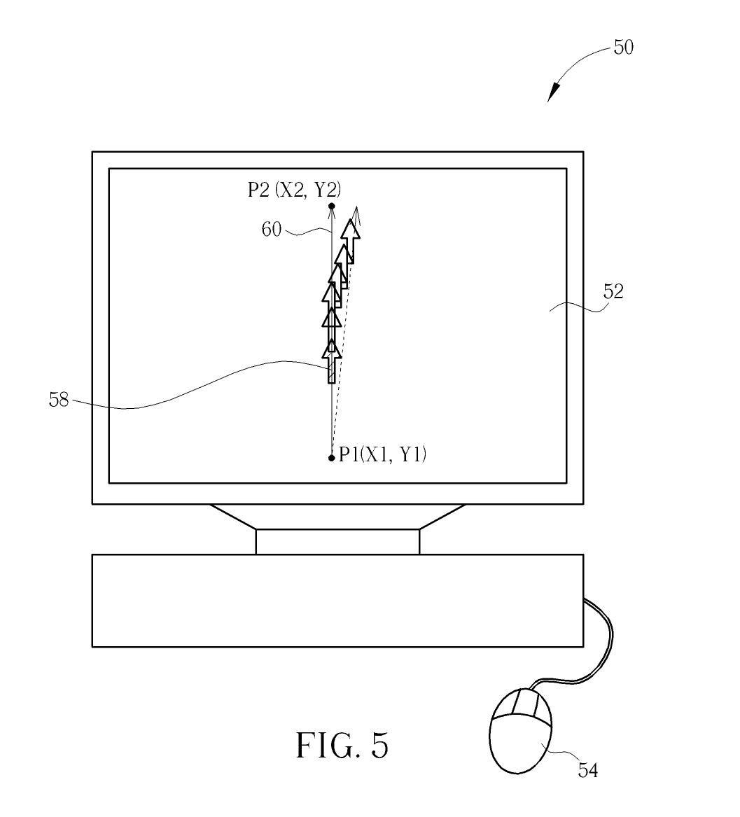

Step 110: Set a predetermined tracing path 60 of the cursor 58 on the displaying device 52 as shown in FIG. 5;

Step 112: Manipulate the pointing device 54 for moving the cursor 58 on the displaying device 52;

Step 114: Identify whether the movement of the cursor 58 on the displaying device 52 overlaps in the predetermined tracing path 60. If yes, execute step 116. If no, execute step 120;

Step 116: Identify whether a distance of moving the cursor 58 on the displaying device 52 is larger than a predetermined distance. If yes, execute step 118. If no, execute step 114.

Step 118: The cursor 58 interactive with the pointing device 54 on the displaying device 52 succeeds in passing the test.

Step 120: The cursor 58 interactive with the pointing device 54 on the displaying device 52 fails in the test.

Step 100 to step 104 illustrates a regional test of the pointing device 54, so as to test whether the cursor 58 interactive with the pointing device 54 can be positioned correctly. As shown in FIG. 3, the displaying device 52 regularly or irregularly sets at least one checking area 56 whereinto the cursor 58 moves. For example, a plurality of checking areas 56 can be set at four corners, a central point, and the other regions on a screen image of the displaying device 52. A method of displaying the plurality of checking areas 56 on the displaying device 52 can include displaying the plurality of checking areas 56 sequentially. The method can further include displaying the plurality of checking areas 56 simultaneously and marking the checking area 56 whereinto the cursor 58 moves by coloring or twinkling. Then, the user manipulates the pointing device 54 for moving the corresponding cursor 58 interactive with the pointing device 54 on the displaying device 52 into the checking area 56. For example, the user can manipulate the mouse to click the checking area 56 or utilize the touch pen or the finger to click a corresponding position of the checking area 56. As the cursor 58 is in the checking area 56 correctly, the cursor 58 interactive with the pointing device 54 on the displaying device 52 succeeds in passing the regional test. As the cursor 58 is not in the checking area 56 correctly, the cursor 58 interactive with the pointing device 54 on the displaying device 52 fails in the regional test, that is to say, the pointing device 54 can not position the cursor 58 at the correct position. Besides, the determination of the position of the cursor can utilize human eyes or the computer system 50 to identify whether a position of the cursor 58 matches with the checking area 56. The regional test is for sifting the pointing device 54 unable to position the cursor correctly and for sifting the touch screen unable to position the cursor correctly.

After the cursor 58 interactive with the pointing device 54 on the displaying device 52 succeeds in passing the regional test, step 106 and step 108 are executed as a pointing test of the pointing device 54. As electronic components, such as the pointing device 54, a signal cable, a circuit board, and so on, are interfered to transmit wrong signal by noise easily, the pointing device 54 may not locate coordinates of the cursor 58 correctly. The pointing test includes the pointing device 54 pointing at a point continuously, which means the user does not control the pointing device 54 to point to the point on the displaying device 52 so as to ensure whether the movement of the cursor 58 interactive with the pointing device 54 makes change in the testing period. For example, a first coordinates at an initial time under the testing process and a second coordinates at a final time under the testing process are captured, and a difference of the second coordinates and the first coordinates is compared with a predetermined value. The predetermined value relates to allowable tolerance of the cursor 58 interactive with the pointing device 54, such as a range of specific pixel amount. As the difference of the second coordinates and the first coordinates is smaller than the predetermined value, it can be considered the cursor 58 interactive with the pointing device 54 on the displaying device 52 does not change the position. As the difference of the second coordinates and the first coordinates is larger than the predetermined value, it can be considered the cursor 58 interactive with the pointing device 54 on the displaying device 52 changes the position, which means the pointing device 54 may be interfered to bias when the cursor 58 moves or points at the position. The determination of the position of the cursor can utilize the human eyes or the computer system 50 to identify whether the difference of the second coordinates and the first coordinates is smaller than the predetermined value. The pointing test is for testing whether the cursor 58 interactive with the pointing device 54 on the displaying device 52 moves incorrectly, so as to prevent the cursor 58 from error in operation.

When the cursor 58 interactive with the pointing device 54 on the displaying device 52 succeeds in passing the pointing test, step 110 to step 116 are executed as a slight moving test of the pointing device 54. The slight moving test of the cursor 58 tests whether the cursor 58 generates a shift larger than the allowance tolerance. First, the displaying device 52 displays a predetermined tracing path 60 of the cursor 58. For example, as shown in FIG. 5, the displaying device 52 can display the predetermined tracing path 60 as a straight line or a curved line. The user manipulates the pointing device 54 for moving the cursor 58 along the predetermined tracing path 60 on the displaying device 52, such as moving the cursor 58 along the predetermined tracing path 60 by the mouse or moving the cursor 58 along the predetermined tracing path 60 on the touch panel by the touch pen or the finger. The user can manipulate the pointing device 54 for driving the cursor 58 to position at a coordinates point P1(X1,Y1) of the predetermined tracing path 60. Then the user controls the pointing device 54 for moving the cursor 58 from the coordinates point P1 (X1,Y1) to a coordinates point P2 (X2,Y2) along the predetermined tracing path 60. As the cursor 58 moves, it is identified whether a tracing path of the cursor 58 shown on the displaying device 52 overlaps in the predetermined tracing path 60, such as capturing a coordinates of the cursor 58 when the pointing device 54 moves and identifying whether the coordinates overlaps in a width range of the predetermined tracing path 60. The width range of the predetermined tracing path 60 relates to the allowable tolerance of the cursor 58 interactive with the pointing device 54, such as the range of the specific pixel amount. In addition, the method can further include the cursor 58 selectively positioning on the coordinates point P1 (X1,Y1) or the coordinates point P2 (X2,Y2) of the predetermined tracing path 60 first, and controlling the pointing device 54 for moving the cursor 58 from the coordinates point P1 (X1,Y1) to the coordinates point P2 (X2,Y2) along the predetermined tracing path 60 or from the coordinates point P2 (X2,Y2) to the coordinates point P1 (X1,Y1) along the predetermined tracing path 60. That is to say, the computer system 50 can identify whether the cursor 58 moves to the coordinates point P1 (X1,Y1) or to the coordinates point P2 (X2,Y2) as an initial point. And the other one is a final point of the predetermined tracing path 60.

When the coordinates is identified to overlap in the width range of the predetermined tracing path 60, it represents the cursor 58 moving along the predetermined tracing path 60. Meanwhile, it is identified whether a distance of moving the cursor 58 on the displaying device 52 is larger than or equal to a predetermined distance. The predetermined distance can be a distance between the coordinates point P1 (X1,Y1) and the coordinates point P2 (X2,Y2). It is also identified whether the cursor 58 finishes moving the whole predetermined tracing path 60. As the distance of the cursor 58 moving on the displaying device 52 is smaller than the predetermined distance, it represents that the cursor 58 has not finished moving the whole predetermined tracing path 60 yet. It has to repeat step 114 to identify whether the cursor 58 overlaps in the predetermined tracing path 60 until the cursor 58 moves the whole predetermined tracing path 60. As the distance of the cursor 58 moving on the displaying device 52 is larger than or equal to the predetermined distance, it represents that the cursor 58 has finished moving the whole predetermined tracing path 60 and the slight moving test is finished. As the cursor 58 does not overlap in the predetermined tracing path 60 in step 114, such as identifying the coordinates does not overlap in the width range of the predetermined tracing path 60, it represents that the cursor 58 moves away the predetermined tracing path 60, so that the slight moving test of the cursor 58 interactive with the pointing device 54 on the displaying device 52 fails. That is to say, the pointing device 54 can not control the cursor 58 slightly and accurately. The determination of the position of the cursor can utilize the human eyes or the computer system 50 to identify whether the coordinates overlaps in the width range of the predetermined tracing path 60. The slight moving test is for controlling the pointing device 54 to move between two specific points and for limiting the shift between the two specific points so as to test whether the pointing device 54 or the touch panel can control the cursor 58 slightly and accurately. In addition, the slight moving test can execute multiple directions selectively, and it depends on design demand.

In conclusion, the method of testing the cursor 58 interactive with the pointing device 54 on the displaying device 52 of the present invention integrates the regional test, the pointing test, and the slight moving test. The regional test can ensure whether the pointing device 54 can move the cursor 58 on the displaying device 52 so as to sift the pointing device 54 unable to position correctly or the touch panel unable to position correctly, which is a basic test. The pointing test can ensure whether the cursor 58 interactive with the pointing device 54 or the touch panel moves out of control, so as to prevent the cursor 58 from bias when the pointing device 54 moves or points to the point. The slight moving test can ensure whether the pointing device 54 can control the movement of the cursor 58 slightly and accurately, so as to prevent the cursor 58 interactive with the pointing device 54 or the touch panel from shift in the slight movement. Besides, the slight moving test can selectively execute the multiple directions. The sequence of the regional test, the pointing test, and the slight moving test of the present invention are not limited to the above-mentioned embodiment. For example, the pointing test and the slight moving test can be executed before the regional test, the operating principle is the same as the above-mentioned embodiment, and detailed description is omitted herein for simplicity. Further, the regional test, the pointing test, and the slight moving test can be executed selectively according to actual demand. For example, the method of testing the cursor 58 interactive with the pointing device 54 on the displaying device 52 can include the pointing test and the slight moving test and omit the regional test according to actual demand. The operating principle is the same as the above-mentioned embodiment and detailed description is omitted herein for simplicity.

Comparing to the prior art, the method of testing the cursor interactive with the pointing device on the displaying device of the present invention integrates the regional test, the pointing test, and the slight moving test, so as to inspect operational faults of the pointing device and the touch panel effectively and to increase reliability and accuracy of the pointing device and the touch panel.

Those skilled in the art will readily observe that numerous modifications and alterations of the device and method may be made while retaining the teachings of the invention.

What is claimed is:

1. A method of testing a cursor interactive with a pointing device on a displaying device comprising:
pointing at a position on a displaying device by the pointing device within a predetermined period;
identifying whether a movement of the cursor makes any change corresponding to the pointing device; and
concluding a testing result in accordance with the movement of the cursor.

2. The method of claim 1, wherein identifying whether a movement of the cursor makes any change corresponding to the pointing device comprises capturing a first coordinates value of the cursor at an initial time under the testing process and capturing a second coordinates value of the cursor at an ending time under the testing process so as to identify whether a difference of the second coordinates value and the first coordinates value is smaller than a predetermined value.

3. The method of claim 2, wherein identifying the movement of the cursor without making change when the difference of the second coordinates value and the first coordinates value is smaller than the predetermined value.

4. The method of claim 2, wherein identifying the movement of the cursor making change when the difference of the second coordinates value and the first coordinates value is larger than the predetermined value.

5. The method of claim 1, wherein pointing at the position on the displaying device by the pointing device within predetermined period comprises pointing at the position on the displaying device in a touch manner within the predetermined period.

6. The method of claim 1 further comprising:
setting the predetermined tracing path of the cursor on the displaying device;
displaying the movement of the cursor when manipulating the pointing device;
identifying whether the movement of the cursor overlaps in the predetermined tracing path; and
displaying a conclusive result on the displaying device in accordance with the identified movement of the cursor corresponding to the pointing device.

7. The method of claim 6, wherein identifying whether the movement of the cursor overlaps in the predetermined tracing path comprises identifying whether the movement of the cursor on the displaying device overlaps in a width range of the predetermined tracing path.

8. The method of claim 7, wherein identifying whether the movement of the cursor overlaps in the width range of the predetermined tracing path comprises capturing a coordinates value of the cursor while moving the pointing device and identifying whether the coordinates value overlaps in the width range of the predetermined tracing path.

9. The method of claim 6 further comprising:
identifying whether a distance of moving the cursor on the displaying device is larger than or equal to a predetermined distance.

10. The method of claim 1 further comprising:
displaying at least one checking area on the displaying device;
manipulating the pointing device for moving the cursor into the checking area; and
identifying whether the cursor moves into the checking area so as to generate the testing result of the cursor.

11. A method of testing a cursor interactive with a pointing device comprising:
setting a predetermined tracing path of the cursor on a displaying device;
displaying a movement of the cursor when manipulating the pointing device;
identifying whether the movement of the cursor overlaps in the predetermined tracing path; and
displaying a conclusive result on the displaying device in accordance with the identified movement of the cursor corresponding to the pointing device.

12. The method of claim 11, wherein identifying whether the movement of the cursor overlaps in the predetermined tracing path comprises identifying whether the movement of the cursor on the displaying device overlaps in a width range of the predetermined tracing path.

13. The method of claim 12, wherein identifying whether the movement of the cursor on the displaying device overlaps in the width range of the predetermined tracing path comprises capturing a coordinates value of the cursor while moving the pointing device and identifying whether the coordinates value overlaps in the width range of the predetermined tracing path.

14. The method of claim 11 further comprising:
identifying whether the distance of moving the cursor on the displaying device is larger than or equal to a predetermined distance.

15. The method of claim 11 further comprising:
pointing at a position on the displaying device by the pointing device within a predetermined period;
identifying whether the movement of the cursor makes any change corresponding to the pointing device; and
concluding a testing result in accordance with the movement of the cursor.

16. The method of claim 15, wherein identifying whether the movement of the cursor makes any change corresponding to the pointing device comprises capturing a first coordinates value of the cursor at an initial time under the testing process and capturing a second coordinates value of the cursor at an ending time under the testing process so as to identify whether a difference of the second coordinates value and the first coordinates value is smaller than a predetermined value.

17. The method of claim 16, wherein identifying the movement of the cursor without making change when the difference of the second coordinates value and the first coordinates value is smaller than the predetermined value.

18. The method of claim 16, wherein identifying the movement of the cursor making change when the difference of the second coordinates value and the first coordinates value is larger than the predetermined value.

19. The method of claim 15, wherein pointing at the position on the displaying device by the pointing device within the predetermined period comprises pointing at the position on the displaying device in a touch manner within the predetermined period.

20. The method of claim 11 further comprising:
displaying at least one checking area on the displaying device;
manipulating the pointing device for moving the cursor into the checking area; and
identify whether the cursor moves into the checking area so as to generate the testing result of the cursor.
